(19) United States
(12) Patent Application Publication
(10) Pub. No.: US 2013/0039680 A1
(43) Pub. Date: Feb. 14, 2013

(54) COLOR IMAGE FORMING APPARATUS AND COLOR MISALIGNMENT ADJUSTING METHOD

(71) Applicants: Yuji KUMAGAI, Osaka (JP); Norio Tomita, Osaka (JP); Kiyoshi Sasoh, Osaka (JP)

(72) Inventors: Yuji KUMAGAI, Osaka (JP); Norio Tomita, Osaka (JP); Kiyoshi Sasoh, Osaka (JP)

(21) Appl. No.: 13/554,478

(22) Filed: Jul. 20, 2012

(30) Foreign Application Priority Data
Aug. 12, 2011 (JP) 2011-177010

(51) Int. Cl. G03G 15/01

(52) U.S. Cl. 399/301

(57) ABSTRACT

According to a color image forming apparatus, a plurality of detection patterns respectively corresponding to a plurality of colors are formed from a plurality of photosensitive body units respectively corresponding to the plurality of colors onto a transfer member in a sub-scanning direction of the transfer member, intervals between detection patterns adjacent to each other in the sub-scanning direction among the plurality of formed detection patterns are detected, and adjustment of color misalignment is performed based on the detected intervals. The plurality of detection patterns have the same size and the same shape. In this color image forming apparatus, the adjustment of color misalignment is performed using at least two types of data of detection images having different intervals as data of detection images including the plurality of detection patterns.

### BACKGROUND OF THE INVENTION

This application claims priority under 35 U.S.C. §119 (a) on Patent Application No. 2011-177010 filed in Japan on Aug. 12, 2011, the entire contents of which are herein incorporated by reference.

The present invention relates to a color image forming apparatus and a color misalignment adjusting method that correct color misalignment of images using a plurality of colors.

Conventionally, in a color image forming apparatus (hereinafter, referred to as an “image forming apparatus”), an electrostatic latent image is formed by irradiating a photosensitive body such as a photosensitive drum with laser beams modulated according to image data, the electrostatic latent image formed on the photosensitive body is developed with toner, and the toner image is formed on a transfer member such as an intermediate transfer belt (see JP 2003-149907A (Patent Document 1), for example).

The image forming apparatus according to Patent Document 1 includes a plurality of image forming portions respectively corresponding to a plurality of colors, wherein images of the respective colors are transferred in a superimposed manner from the plurality of image forming portions to an endless belt (transfer member), and then, the images transferred in a superimposed manner are transferred in a batch to a recording paper, forming a color image on the recording paper.

In the image forming apparatus as described in Patent Document 1, due to factors such as misalignment between installation positions of a plurality of image forming portions occurring when installing the plurality of image forming portions, errors in the optical path length of a laser beam, changes in the optical path, warping of an LED functioning as a light source caused by the environmental temperature, or the like, misalignment between the positions of images of the respective colors formed on the photosensitive bodies may occur. Due to this misalignment, when transferring the respective colors from the plurality of photosensitive bodies in a superimposed manner, the respective colors cannot be transferred to desired positions on the endless belt, and, therefore, color misalignment occurs on the endless belt.

In order to correct this color misalignment, conventional image forming apparatuses are provided with adjustment means for adjusting positional misalignment.

According to this adjustment means, detection patterns respectively corresponding to a plurality of colors are formed on an endless belt in a sub-scanning direction by a plurality of image forming portions (specifically, photosensitive bodies). Then, the intervals between detection patterns adjacent to each other in the sub-scanning direction among the detection patterns formed on the endless belt are detected using light from an optical sensor such as a CCD, color misalignment at the time of development is detected using the detected data, and the optical path length is automatically corrected according to the color misalignment amount.

In the conventional correction of color misalignment as described in Patent Document 1, since toner images for detection are formed on the transfer member (endless belt), toner is consumed for the detection. The amount of toner consumed increases in proportion to the detection pattern data as the size of the detection pattern data increases. Thus, in order to reduce the amount of toner consumed, it is desirable to reduce the area of the detection patterns.

However, if the area of the detection patterns is reduced in order to reduce the amount of toner consumed, the outline of the toner images becomes blurred, and, as a result, the detection precision decreases. In order to avoid a decrease in the detection precision, it is necessary to increase the size of the detection patterns, but this countermeasure is problematic in that the amount of toner consumed cannot be suppressed as described above.

In order to solve the above-described problems, it is an object of the present invention to provide a color image forming apparatus and a color misalignment adjusting method that can improve the detection precision while suppressing the amount of toner consumed.

### SUMMARY OF THE INVENTION

In order to achieve the above-described object, the present invention is directed to a color image forming apparatus, wherein a plurality of detection patterns respectively corresponding to a plurality of colors are formed from a plurality of photosensitive body units respectively corresponding to the plurality of colors onto a transfer member in a sub-scanning direction of the transfer member, intervals between detection patterns adjacent to each other in the sub-scanning direction among the plurality of formed detection patterns are detected, and adjustment of color misalignment is performed based on the detected intervals, the plurality of detection patterns have the same size and the same shape, and the adjustment of color misalignment is performed using at least two types of data of detection images having different intervals as data of detection images including the plurality of detection patterns.

According to the present invention, since the adjustment of color misalignment is performed using at least two types of data of detection images having different intervals, a plurality of adjustment choices can be provided for the adjustment of color misalignment. As a result, the adjustment of color misalignment can be performed with a given level of precision depending on occasions such as those when performing initial settings or when performing maintenance after use of the color image forming apparatus. That is to say, the detection can be performed with an optimal level of precision depending on the conditions. Furthermore, the amount of toner consumed can be suppressed whichever type of data of detection images is used to perform the adjustment of color misalignment. In a specific embodiment of the present invention, since a plurality of types of data of detection images are used, the adjustment of color misalignment can be performed in a sequential or stepwise manner from rough adjustment to fine adjustment, and the correction of color misalignment can be precisely performed.

The above-described configuration may be such that the data of detection images include two types of data composed of first data of detection images and second data of detection images having an interval smaller than that of the first data, and that, after the adjustment of color misalignment using the first data is performed, the adjustment of color misalignment using the second data is performed.

According to the present invention, since the rough adjustment of color misalignment is performed based on the first data having a large interval, after which the fine adjustment of color misalignment is performed based on the second data having a small interval, the correction of color misalignment can be precisely performed.

The above-described configuration may be such that the adjustment of color misalignment is performed based on a preset condition using the first data and the second data.

In this case, the rough adjustment of color misalignment using the first data can be performed based on a preset condition (e.g., at the time of initial settings) where the color misalignment amount may be significant, and the fine adjustment of color misalignment using the second data can be periodically performed based on a preset condition in ordinary use (e.g., the time). As a result, since the rough adjustment of color misalignment using the first data has been performed in advance, misalignment in the fine adjustment of color misalignment using the second data is slight, and the adjustment of color misalignment can be more precisely performed. On the other hand, if the adjustment of color misalignment using the second data is performed under, for example, the conditions at the time of initial settings, since the range in which the adjustment of color misalignment can be performed is narrow, misalignment between installation positions when installing the image forming portion such as a plurality of photosensitive body units has to be substantially eliminated. Thus, with the technique at the time of the present application, it is difficult to perform adjustment of color misalignment using the second data when the color misalignment amount may be significant, for example, at the time of initial settings.

In order to achieve the above-described object, the present invention is further directed to a color misalignment adjusting method of a color image forming apparatus, including: a formation step of forming a plurality of detection patterns respectively corresponding to a plurality of colors from a plurality of photosensitive body units respectively corresponding to the plurality of colors onto a transfer member in a sub-scanning direction of the transfer member; and an adjustment step of detecting intervals between detection patterns adjacent to each other in the sub-scanning direction among the plurality of detection patterns formed in the formation step, and performing adjustment of color misalignment based on the detected intervals; wherein the plurality of detection patterns have the same size and the same shape, and the adjustment of color misalignment is performed in the adjustment step using at least two types of data of detection images having different intervals as data of detection images including the plurality of detection patterns.

According to the present invention, since the method includes the formation step and the adjustment step, and the adjustment of color misalignment is performed using at least two types of data of detection images having different intervals, a plurality of adjustment choices can be provided for the adjustment of color misalignment. As a result, the adjustment of color misalignment can be performed with a given level of precision depending on occasions such as those when performing initial settings or when performing maintenance after use of the color image forming apparatus. That is to say, the detection can be performed with an optimal level of precision depending on the conditions. Furthermore, the amount of toner consumed can be suppressed whichever type of data of detection images is used to perform adjustment of color misalignment. In a specific embodiment of the present invention, since a plurality of types of data of detection images are used, the adjustment of color misalignment can be performed in a sequential or stepwise manner from rough adjustment to fine adjustment. In this case, the correction of color misalignment can be precisely performed.

### BRIEF DESCRIPTION OF THE DRAWINGS

FIG. 1 is a schematic cross-sectional front view showing the overall configuration an image forming apparatus according to an embodiment.

FIG. 2 is a schematic block diagram showing essential constituent components of the image forming apparatus according to this embodiment.

FIG. 3 is a diagram showing detection patterns for rough adjustment used in the adjustment of color misalignment according to this embodiment.

FIG. 4 is a diagram showing detection patterns for fine adjustment used in the adjustment of color misalignment according to this embodiment.

FIG. 5 is a flowchart for the adjustment of color misalignment according to this embodiment.

### DESCRIPTION OF REFERENCE NUMERALS

1 Light exposure unit
2 Development unit
3 Photosensitive drum
4 Photosensitive body unit
5 Charging unit
6 Intermediate transfer belt unit
7 Fixing unit
8 Pre-transfer charging unit
10 Transfer roller
11a, 11b Pickup roller
12a, 12b, 12c, 12d Transport roller
13 Registration roller
21 Toner cartridge unit
61 Intermediate transfer belt
62 Drive roller
63 Idler roller
64 Intermediate transfer roller
65 Cleaning unit
71 Heat roller
71a Heater
71b Temperature detector
72 Pressure roller
73 External heating belt
81 Paper feed tray
82 Manual paper feed tray
90 Optical unit
91 Paper discharge tray
92 Document placement platen
100 Image forming apparatus
102 Image forming portion
103 Paper transport system
108 Document reading device
110 Apparatus main body
200 Image forming unit
300 Main control portion
301 Input portion
302 Display portion
303 Storage portion
304 Image processing operation portion
305 Network
306 Network interface
307 Telephone line
308 Facsimile portion
309 Bus
310 Sensor portion
D1 First data
D2 Second data
P1, P2, P3, P4 Detection pattern
PB Detection pattern block
S Paper transport path

### DESCRIPTION OF THE EMBODIMENT

Hereinafter, an embodiment according to the present invention will be described with reference to the drawings.

<Description of the Overall Configuration of the Image Forming Apparatus>

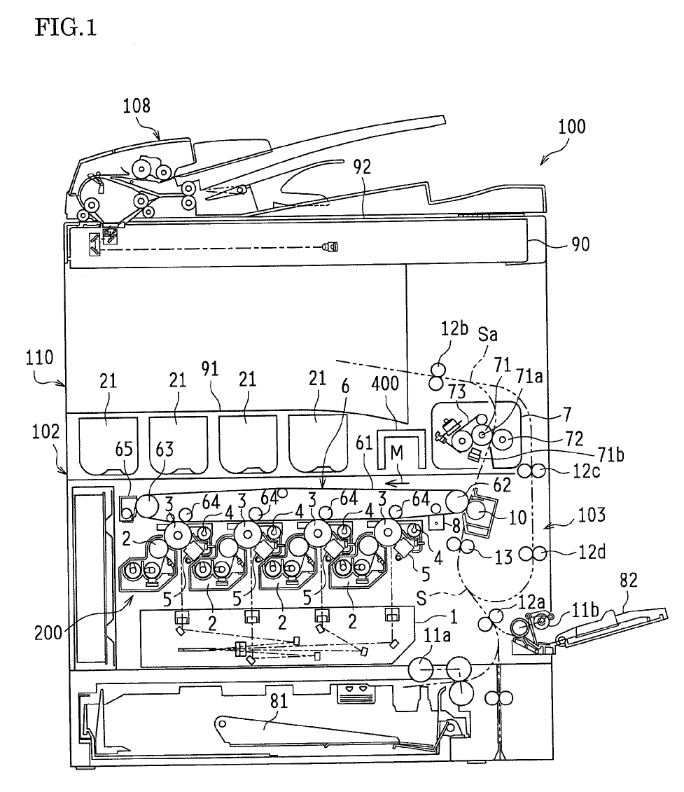

FIG. 1 is a schematic cross-sectional front view showing the overall configuration of an image forming apparatus 100 according to this embodiment.

The image forming apparatus 100 shown in FIG. 1 is a color image forming apparatus that forms an image using at least one color (a plurality of colors or a single color) on a sheet such as a recording paper (hereinafter, referred to as a “recording paper”) according to image data transmitted from the outside.

The image forming apparatus 100 includes a document reading device 108 and an apparatus main body 110. The apparatus main body 110 is provided with an image forming portion 102 and a paper transport system 103.

The image forming portion 102 includes a light exposure unit 1, a plurality of development units 2, a plurality of photosensitive body units 4, an intermediate transfer belt unit 6, a pre-transfer charging unit 8, a plurality of toner cartridge units 21, and a fixing unit 7. In this embodiment, the light exposure unit 1, the development units 2, the photosensitive body units 4, the intermediate transfer belt unit 6, and the toner cartridge units 21 function as a plurality of freely detachable image forming units 200 that perform different image forming operations. Here, it is assumed that the photosensitive body units 4 are units each formed by combining a unit for photosensitive operations, a unit for charging, and a unit for cleaning into one unit.

Furthermore, the paper transport system 103 includes a paper feed tray 81, a manual paper feed tray 82, and a paper discharge tray 91.

A document placement platen 92 made of transparent glass on which a sheet such as a document (hereinafter, referred to as a “document”) is to be placed is provided above the apparatus main body 110, and an optical unit 90 for reading a document is provided below the document placement platen 92. Furthermore, the document reading device 108 is provided above the document placement platen 92.

Image data processed in the image forming apparatus 100 corresponds to a color image using a plurality of colors (colors consisting of black (K), cyan (C), magenta (M), and yellow (Y), in this example). Accordingly, for each unit group of the development units 2, the photosensitive body units 4 (including photosensitive bodies in the present invention), and the toner cartridge units 21, a plurality of units (four units, respectively corresponding to black, cyan, magenta, and yellow, in this example) are provided in order to form a plurality of types (four types in this example) of images corresponding to the respective colors, and these units form image stations for the respective colors (four colors, in this example).

In the photosensitive body units 4, charging units 5 are charging means for uniformly charging the surfaces of photosensitive drums 3 to a predetermined potential, and, as the charging units 5, charging units of contact type such as rollers or brushes can be used as well as those of charger type as shown in FIG. 1.

The light exposure unit 1 is configured as a laser scanning unit (LSU) including a laser emitting portion and reflective mirrors. The light exposure unit 1 is provided with a polygon mirror scanned by a laser beam, and optical elements such as lenses and mirrors for guiding the laser beam reflected by the polygon mirror to the photosensitive drums 3. Furthermore, for the light exposure unit 1, other concepts can be used, such as a concept employing a writing head in which light-emitting elements such as EL (electroluminescence) elements or LEDs (light-emitting diodes) are arranged in an array.

The light exposure unit 1 irradiates the photosensitive drums 3 that are charged according to input image data, thereby forming electrostatic latent images according to the image data on the respective surfaces of the photosensitive drums 3.

The toner cartridge units 21 are units containing toner, and are configured such that the toner is supplied to development baths of the development units 2. In the apparatus main body 110 of the image forming apparatus 100, the toner supplied from the toner cartridge units 21 to the development baths of the development units 2 is controlled such that the toner concentration of a developer in the development baths is constant.

The development units 2 make the electrostatic latent images formed on the respective photosensitive drums 3 visible with toner of the four colors (Y, M, C, and K). Furthermore, the photosensitive body units 4 further have a cleaning function of removing and recovering toner that has remained on the surfaces of the photosensitive drums 3 after development and image transfer.

The intermediate transfer belt unit 6 disposed above the photosensitive drums 3 includes an intermediate transfer belt 61 functioning as an intermediate transfer member, a drive roller 62, an idler roller 63, a plurality of intermediate transfer rollers 64, and a cleaning unit 65.

Four intermediate transfer rollers 64 are provided respectively corresponding to colors Y, M, C, and K. The drive roller 62 supports the intermediate transfer belt 61 in a tensioned state in cooperation with the idler roller 63 and the intermediate transfer rollers 64. When the drive roller 62 is driven to rotate, the intermediate transfer belt 61 is revolved in the movement direction (direction indicated by arrow M in FIG. 1), which causes the idler roller 63 and the intermediate transfer rollers 64 to be idly rotated.

The intermediate transfer rollers 64 are supplied with a transfer bias for transferring toner images formed on the photosensitive drums 3 to the intermediate transfer belt 61.

The intermediate transfer belt 61 is provided so as to be in contact with each of the photosensitive drums 3. Toner images of the respective colors formed on the photosensitive drums 3 are sequentially transferred to the intermediate transfer belt 61 so as to be superimposed one after another, so that a color toner image (multicolor toner image) can be formed on the surface of the intermediate transfer belt 61. The intermediate transfer belt 61 is, for example, formed in the form of an endless belt made of a film having a thickness of approximately 100 μm to 150 μm.

Toner images are transferred from the photosensitive drums 3 to the intermediate transfer belt 61 by means of the intermediate transfer rollers 64 that are in contact with the back face of the intermediate transfer belt 61. The intermediate transfer rollers 64 are supplied with a high voltage transfer bias (high voltage having a polarity (+) opposite the polarity (−) of the charged toner) for transferring toner images. The intermediate transfer rollers 64 are each made by forming its core with a metal (e.g., stainless steel) shaft having a diameter of 8 mm to 10 mm and covering the surface of the core with a conductive elastic material (e.g., EPDM (ethylene propylene diene rubber) or resin material such as foamed urethane). The intermediate transfer rollers 64 function as transfer electrodes that apply a high voltage uniformly to the intermediate transfer belt 61 with the conductive elastic material. Although roller-like transfer electrodes are used as the transfer electrodes in this embodiment, other transfer electrodes such as brush-like transfer electrodes can be used.

As described above, toner images that are made visible according to the color phases on the respective photosensitive drums 3 are superimposed on the intermediate transfer belt 61. When the intermediate transfer belt 61 is revolved, the toner images superimposed on the intermediate transfer belt 61 are transferred to a recording paper by a transfer roller 10 that forms a second transfer mechanism portion disposed in a contact position where the recording paper is in contact with the intermediate transfer belt 61. Note that, as the configuration of the second transfer mechanism portion, not only transfer rollers but also other transfer configurations such as those employing corona chargers or transfer belts can be used.

At this time, the transfer roller 10 is supplied with a voltage (high voltage having a polarity (+) opposite the polarity (−) of the charged toner) for transferring toner to the recording paper in a state where a transfer nip is formed between the transfer roller 10 and the intermediate transfer belt 61. The transfer nip is formed between the transfer roller 10 and the intermediate transfer belt 61 by the transfer roller 10 and the drive roller 62 pressing against each other. In order to maintain the transfer nip steadily, either one of the transfer roller 10 and the drive roller 62 is a hard roller made of a hard material (e.g., metal), and the other is an elastic roller made of a soft material (e.g., elastic rubber or resin material such as foamed resin).

When transferring a toner image from the intermediate transfer belt 61 to a recording paper with the transfer roller 10, toner may remain on the intermediate transfer belt 61 without being transferred to the recording paper. The toner that has remained on the intermediate transfer belt 61 will cause mixture of toner colors in subsequent processes. Therefore, the toner that has remained on the intermediate transfer belt 61 is removed and recovered by the cleaning unit 65. Specifically, the cleaning unit 65 includes a cleaning member (e.g., a cleaning blade) that is in contact with the intermediate transfer belt 61. The idler roller 63 supports the intermediate transfer belt 61 from the inside (back face side), and the cleaning member is in contact with the intermediate transfer belt 61 so as to press the intermediate transfer belt 61 toward the idler roller 63 from the outside.

The pre-transfer charging unit 8 in this example has a pre-transfer charger (PTC), and is provided near the intermediate transfer belt 61 on the upstream side of the transfer nip between the transfer roller 10 and the intermediate transfer belt 61 and on the downstream side of the photosensitive body units 4 in the movement direction M of the intermediate transfer belt 61.

Incidentally, the toner images that are transferred from the photosensitive drums 3 to the intermediate transfer belt 61 include halftone areas or solid areas, or include areas having different numbers of toner layers, and, therefore, the charge level may vary from area to area. Furthermore, the charge level within a toner image on the intermediate transfer belt 61 after the primary transfer may vary due to exfoliation discharges generated in a gap on the downstream side adjacent to the primary transfer portion in the movement direction M of the intermediate transfer belt 61. Such variations in the charge level in the same toner image decrease the transfer margin when transferring a toner image on the intermediate transfer belt 61 to a sheet.

Therefore, the pre-transfer charging unit 8 is used to uniformly charge a toner image before transfer to a sheet, so that the variations in the charge level in the same toner image are cancelled, which makes it possible to improve the transfer margin in the secondary transfer.

Furthermore, the apparatus main body 110 is provided with a paper transport path S such that a recording paper from the paper feed tray 81 and the manual paper feed tray 82 is transported via the transfer roller 10 and the fixing unit 7 to the paper discharge tray 91. Arranged in the vicinity of the paper transport path S are pickup rollers 11a and 11b, a plurality of transport rollers 12a to 12d, registration rollers 13, the transfer roller 10, and a heat roller 71 and a pressure roller 72 in the fixing unit 7.

The registration rollers 13 temporarily hold a recording paper that is being transported on the paper transport path S. Then, the registration rollers 13 transport the recording paper to the transfer roller 10 at a timing where the leading edge of the toner image on the photosensitive drums 3 is aligned with the leading edge of the recording paper.

The fixing unit 7 fixes an unfixed toner image onto the recording paper, and includes the heat roller 71 and the pressure roller 72 that function as fixing rollers. The heat roller 71 is heated with a heater 71a provided inside it, and is kept at a predetermined fixing temperature based on a signal from a temperature detector 71b. The fixing unit 7 is further provided with an external heating belt 73 for heating the heat roller 71 from the outside.

In the thus configured image forming apparatus 100, when there is a request for simplex printing on a recording paper, a recording paper fed from the paper feed tray 81 or the manual paper feed tray 82 is transported to the registration rollers 13 with the transport rollers 12a arranged along the paper transport path S, and is transported by the transfer roller 10 at a timing where the leading edge of the recording paper is aligned with the leading edge of the toner image on the intermediate transfer belt 61, and then the toner image is transferred to the recording paper. Subsequently, the recording paper passes through the fixing unit 7, so that unfixed toner on the recording paper is melted by heat and adheres to the recording paper, and then the recording paper is discharged to the paper discharge tray 91 through the transport rollers 12b.

When there is a request for duplex printing on a recording paper, in a state where the simplex printing as described above is completed and the trailing edge of the recording paper that has passed through the fixing unit 7 is positioned between the last transport rollers 12b and a branching portion Sa on the paper transport path S, the transport rollers 12b are rotated in reverse, and, therefore, the recording paper is guided to the transport rollers 12c and 12d. Then, the recording paper that has been transported to the transfer nip through the registration rollers 13 undergoes printing on its back face, and then is discharged onto the paper discharge tray 91.

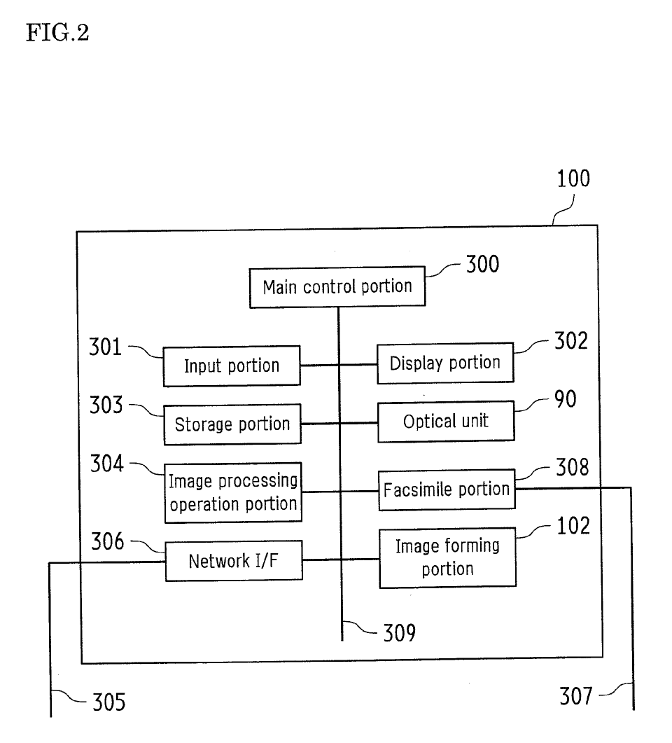

The thus configured image forming apparatus 100 according to this embodiment includes essential constituent components shown in FIG. 2. Specifically, the image forming apparatus 100 is provided with a main control portion 300 that controls various operations of the image forming apparatus 100, an input portion 301 on which a user directly performs an input operation, a display portion 302 that displays information such as an image, a storage portion 303 that stores image data and the like, an image processing operation portion 304 that performs an image processing operation, a network interface 306 (network I/F) that is connected to the outside via a network 305, the optical unit 90 that scans a document, the image forming portion 102 that forms an image of a document on a recording paper, and a facsimile portion 308 that is connected to the outside (that transmits a FAX) via a telephone line 307. These constituent components are connected to each other via a bus 309 such that image data (signals) can be transmitted and received.

The main control portion 300 controls the input portion 301, the display portion 302, the storage portion 303, the image processing operation portion 304, the network interface 306, the optical unit 90, the image forming portion 102, and the facsimile portion 308. For example, the main control portion 300 causes the image forming portion 102 to perform a printing process (image forming process) based on image data received via the network interface 306. Furthermore, the main control portion 300 causes the facsimile portion 308 to perform a facsimile transmitting process that dials a designated destination phone number and transmits image data that is a transmission target. Furthermore, the main control portion 300 causes the optical unit 90 to perform a scanning process that reads an image formed on a document. In this manner, the main control portion 300 causes these constituent components of the image forming apparatus 100 to perform various operations based on input from the input portion 301, input from the outside via the network interface 306, input from the outside via the facsimile portion 308, and the like.

The image forming portion 102 is a so-called imaging engine that is controlled by the main control portion 300, and refers to a group consisting of a device that forms (outputs) an image on a recording paper at an image formation position based on document image data, printing image data, and the like, and a constituent component such as an MPU that controls the device.

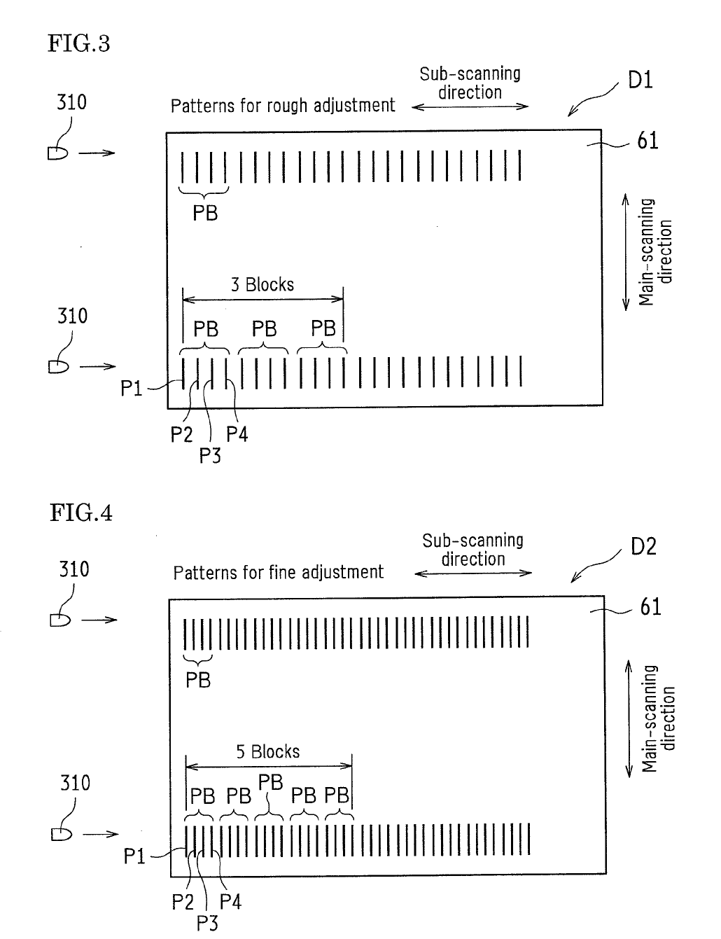

Incidentally, the image forming apparatus 100 according to this embodiment is provided with an adjustment means for adjusting positional misalignment in order to correct color misalignment of an image. The adjustment means includes sensor portions 310 that are provided in the image forming portion 102 (see FIGS. 3 and 4). The main control portion 300 controls the image forming portion 102 to perform adjustment of positional misalignment using the adjustment means, so that detection patterns respectively corresponding to the four respective colors (see P1, P2, P3, and P4 shown in FIGS. 3 and 4) are formed on the intermediate transfer belt 61, the sensor portions 310 are used to detect whether or not there is positional misalignment between the detection patterns P1, P2, P3, and P4, and, if there is positional misalignment, the optical path length in the LSU is corrected. As the sensor portions 310 in this example, an imaging device such as a CCD is used. The detection patterns formed on the intermediate transfer belt 61 are detected by scanning and irradiating the imaging device, and, if color misalignment has occurred, the optical path length in the LSU is corrected.

Hereinafter, the adjustment of positional misalignment using the adjustment means will be described in more detail. First, the detection patterns P1, P2, P3, and P4 respectively corresponding to the four respective colors, which function as references, are set. It is assumed that the detection patterns P1, P2, P3, and P4 are arranged at constant intervals. Furthermore, four detection patterns P1, P2, P3, and P4 form one detection pattern block (symbol PB shown in FIGS. 3 and 4), and such a detection pattern block PB is repeatedly formed a plurality of times in the sub-scanning direction of the sensor portions 310 (imaging devices) (hereinafter, referred to as a “sub-scanning direction”), thereby forming a plurality of detection pattern blocks PB. The storage portion 303 stores data of detection images of four detection patterns P1, P2, P3, and P4 and a plurality of detection pattern blocks PB that have been formed in this manner and intervals between the detection patterns P1, P2, P3, and P4 (hereinafter, referred to as “reference intervals”) as data of reference detection images.

At the time of detection in the adjustment of color misalignment, four image stations sequentially form the detection patterns P1, P2, P3, and P4 (see FIGS. 3 and 4) respectively corresponding to the four respective colors in the sub-scanning direction on the intermediate transfer belt 61.

The intervals between the detection patterns P1, P2, P3, and P4 formed on the intermediate transfer belt 61 are detected by the sensor portions 310, the detected data and the reference interval data are compared with each other to detect color misalignment, and the optical path length is corrected according to the color misalignment amount.

Regarding the adjustment of color misalignment using the above-described adjustment means, in this embodiment, data of detection images having two different intervals (see FIGS. 3 and 4) is stored in the storage portion 303 as reference intervals. Specifically, data of detection images having a reference interval of 6.3 mm as shown in FIG. 3 (hereinafter, referred to as “first data D1”) and data of detection images having a reference interval of 3.8 mm, which is smaller than that of the first data D1, as shown in FIG. 4 (hereinafter, referred to as “second data D2”) are stored.

The first data D1 of detection images is used as reference interval data for rough adjustment of color misalignment. As shown in FIG. 3, the detection images are respectively formed at portions corresponding to both sides in the width direction (upper and lower sides in the drawing) on the intermediate transfer belt 61, the detection patterns P1, P2, P3, and P4 are formed as rectangles having the same size and the same shape, and the longitudinal direction of the patterns matches the main-scanning direction. According to the first data D1 of the detection images having an interval of 6.3 mm, three detection pattern blocks PB can be formed with respect to one revolution of the photosensitive drums 3.

The second data D2 of detection images is used as reference interval data for fine adjustment of color misalignment. As shown in FIG. 4, the detection image are respectively formed at portions corresponding to both sides in the width direction (upper and lower sides in the drawing) on the intermediate transfer belt 61, the detection patterns P1, P2, P3, and P4 are formed as rectangles having the same size and the same shape, and the longitudinal direction of the patterns matches the main-scanning direction. According to the second data D2 of the detection images having an interval of 3.8 mm, five detection pattern blocks PB can be formed with respect to one revolution of the photosensitive drums 3.

The first data D1 and the second data D2 are different from each other only in terms of the interval in the sub-scanning direction, and are the same in terms of the width (the length in the sub-scanning direction), the length (the length in the main-scanning direction), and the color arrangement order of the detection patterns of the respective colors. Thus, the amount of toner consumed in fine adjustment using the second data D2 is only 5/3 of the amount of toner consumed in rough adjustment using the first data D1. Accordingly, it is possible to improve the detection precision while suppressing the amount of toner consumed in correction of color misalignment.

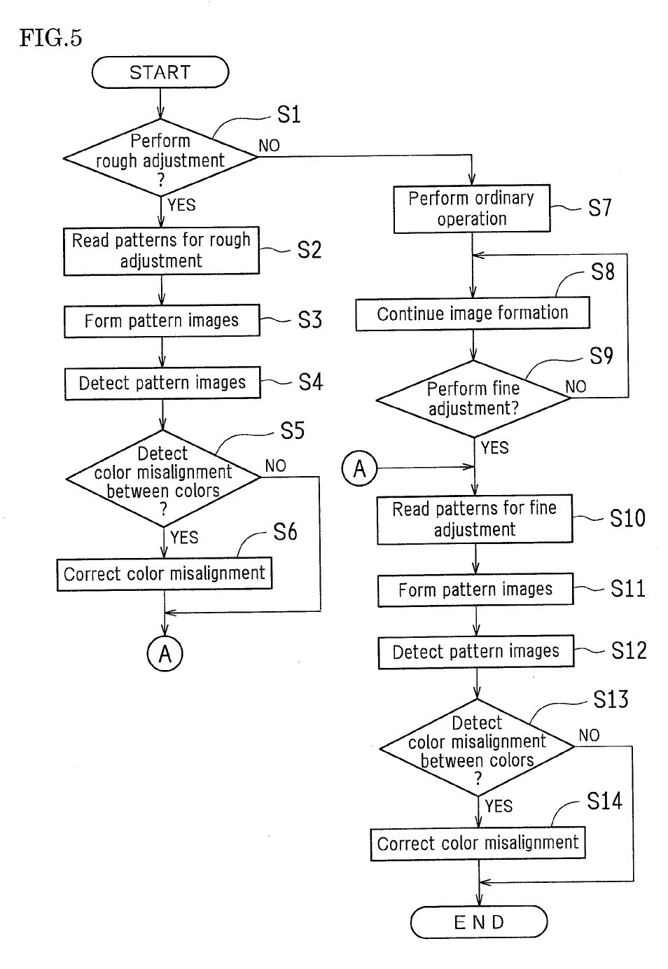

Next, the color misalignment adjusting method using the above-described adjustment means (the first data D1 and the second data D2) will be described in detail with reference to FIG. 5.

If there is a request to perform initial settings of the image forming apparatus 100, for example, when performing inspection in the plant, when installing the image forming apparatus 100, or when performing correction of color misalignment as designated by the user (manual operation), these occasions being conditions preset by the user (YES in Step S1), the first data D1 (the patterns for rough adjustment) is read from the storage portion 303 (Step S2).

After the first data D1 is read in Step S2, the image forming portion 102 uses the photosensitive body units 4 corresponding to the four respective colors to form the detection patterns P1, P2, P3, and P4 on the intermediate transfer belt 61 based on the first data D1 and its related data (reference interval, etc.) (Step S3, which corresponds to the formation step in the present invention).

After the detection patterns P1, P2, P3, and P4 are formed on the intermediate transfer belt 61 as shown in FIG. 3 in Step S3, actual intervals between adjacent detection patterns P1, P2, P3, and P4 are detected by the sensor portions 310 (Step S4).

The data actually detected in Step S4 and the first data D1 are compared with each other to detect color misalignment (Step S5).

If there is color misalignment in Step S5 (YES in Step S5), the optical path length is corrected according to the color misalignment amount (Step S6, which corresponds to the adjustment step in the present invention), and the rough adjustment of color misalignment ends. Next, in order to perform fine adjustment using the second data D2, the second data D2 (the patterns for fine adjustment) is read from the storage portion 303 (Step S10).

Furthermore, if there is no color misalignment in Step S5 (NO in Step S5), the rough adjustment of color misalignment ends. Next, in order to perform fine adjustment using the second data D2 (the patterns for fine adjustment), the second data D2 is read from the storage portion 303 (Step S10).

After the second data D2 is read in Step S10, the image forming portion 102 uses the photosensitive body units 4 corresponding to the four respective colors to form the detection patterns P1, P2, P3, and P4 on the intermediate transfer belt 61 based on the second data D2 and its related data (reference interval, etc.) (Step S11, which corresponds to the formation step in the present invention).

After the detection patterns P1, P2, P3, and P4 are formed on the intermediate transfer belt 61 in Step S11, actual intervals between adjacent detection patterns P1, P2, P3, and P4 are detected by the sensor portions 310 (Step S12).

The data actually detected in Step S12 and the second data D2 are compared with each other to detect color misalignment (Step S13).

If there is color misalignment in Step S13 (YES in Step S13), the optical path length is corrected according to the color misalignment amount (Step S14, which corresponds to the adjustment step in the present invention), and the fine adjustment of color misalignment ends, thereby ending the adjustment of color misalignment.

Furthermore, if there is no color misalignment in Step S13 (NO in Step S13), the fine adjustment of color misalignment ends, thereby ending the adjustment of color misalignment.

Furthermore, if there is no request to perform initial settings of the image forming apparatus 100, for example, when performing inspection in the plant or when installing the image forming apparatus 100 (NO in Step S1), the ordinary image forming operation (image forming process) is performed (Step S7), and the image forming operation (image forming process) is performed based on a preset condition (Step S8). The preset condition in this example may be a condition relating to the image forming process or may be a condition relating to the image forming time. Specifically, the preset condition may be the number of recording papers that have undergone image formation or may be the time at which image formation was performed.

If the preset condition is not satisfied in Step S8 (NO in Step S9), the image forming operation (image forming process) is continuously performed (Step S8).

Furthermore, if the preset condition is satisfied in Step S8 (YES in Step S9), the main control portion 300 automatically (periodically) or forcibly performs fine adjustment of color misalignment (YES in Step S9), and the second data D2 (the patterns for fine adjustment) is read from the storage portion 303 (Step S10).

After the second data D2 is read in Step S10, the image forming portion 102 uses the photosensitive body units 4 corresponding to the four respective colors to form the detection patterns P1, P2, P3, and P4 on the intermediate transfer belt 61 based on the second data D2 and its related data (reference interval, etc.) (Step S11, which corresponds to the formation step in the present invention).

After the detection patterns P1, P2, P3, and P4 are formed on the intermediate transfer belt 61 in Step S11, actual intervals between adjacent detection patterns P1, P2, P3, and P4 are detected by the sensor portions 310 (Step S12).

The data actually detected in Step S12 and the second data D2 are compared with each other to detect color misalignment (Step S13).

If there is color misalignment in Step S13 (YES in Step S13), the optical path length is corrected according to the color misalignment amount (Step S14, which corresponds to the adjustment step in the present invention), and the fine adjustment of color misalignment ends, thereby ending the adjustment of color misalignment.

Furthermore, if there is no color misalignment in Step S13 (NO in Step S13), the fine adjustment of color misalignment ends, thereby ending the adjustment of color misalignment.

In this manner, according to the image forming apparatus 100 according to this embodiment or the color misalignment adjusting method using the image forming apparatus 100, since the first data D1 and the second data D2 having different intervals are used to perform adjustment of color misalignment, two adjustment choices can be provided for the adjustment of color misalignment. As a result, the adjustment of color misalignment can be performed with a given level of precision depending on occasions such as those when performing initial settings or when performing maintenance after use of the image forming apparatus 100. That is to say, the detection can be performed with an optimal level of precision depending on the conditions. Furthermore, the amount of toner consumed can be suppressed whichever type of data of detection images is used to perform adjustment of color misalignment. In this embodiment, since the first data D1 and the second data D2 are used, the adjustment of color misalignment can be sequentially performed from rough adjustment to fine adjustment. In this case, the correction of color misalignment can be precisely performed.

Furthermore, since the main control portion 300 performs rough adjustment of color misalignment based on the first data D1 having an interval larger than that of the second data D2, and then performs fine adjustment of color misalignment based on the second data D2 having an interval smaller than that of the first data D1, the correction of color misalignment can be precisely performed.

Furthermore, since the first data D1 and the second data D2 are used to perform adjustment of color misalignment based on the preset conditions, rough adjustment of color misalignment using the first data D1 can be performed based on a preset condition (e.g., at the time of initial settings) where the color misalignment amount may be significant, and fine adjustment of color misalignment using the second data D2 can be periodically performed based on a preset condition in ordinary use (e.g., the time). As a result, since the rough adjustment of color misalignment using the first data D1 has been performed in advance, misalignment in the fine adjustment of color misalignment using the second data D2 is slight, and the adjustment of color misalignment can be more precisely performed. On the other hand, if the adjustment of color misalignment using the second data D2 is performed under, for example, the conditions at the time of initial settings, since the range in which the adjustment of color misalignment can be performed is narrow, misalignment between installation positions when installing the image forming portion 102 such as the plurality of photosensitive body units 4 has to be substantially eliminated. Thus, with the technique at the time of the present application, it is difficult to perform adjustment of color misalignment using the second data D2 when the color misalignment amount may be significant, for example, at the time of initial settings.

In this embodiment, although the adjustment of color misalignment is performed with respect to four colors, the number of colors is not limited to this. For example, any number is possible as long as it is a plural.

Furthermore, in this embodiment, although the first data D1 and the second data D2 are used to perform adjustment of color misalignment, the number of data types of detection images is not limited to this. For example, three or more data types of detection images may be used. In this case, the adjustment of color misalignment can be performed in a stepwise manner from rough adjustment to fine adjustment, and, therefore, the correction of color misalignment can be more precisely performed.

Note that the color image forming apparatus according to the present invention showing this embodiment as an example is applicable also to other image forming apparatuses such as copiers, printers, and facsimile machines.

The present invention may be embodied in various other forms without departing from the spirit, gist, or essential characteristics thereof. The embodiments disclosed in this application are to be considered in all respects as illustrative and not limiting. The scope of the invention is indicated by the appended claims rather than by the foregoing description. All variations and modifications falling within the meaning and range of equivalency of the appended claims are intended to be embraced therein.

Furthermore, the present invention is effective for color image forming apparatuses.

What is claimed is:

1. A color image forming apparatus,
wherein a plurality of detection patterns respectively corresponding to a plurality of colors are formed from a plurality of photosensitive body units respectively corresponding to the plurality of colors onto a transfer member in a sub-scanning direction of the transfer member, intervals between detection patterns adjacent to each other in the sub-scanning direction among the plurality of formed detection patterns are detected, and adjustment of color misalignment is performed based on the detected intervals,
the plurality of detection patterns have the same size and the same shape, and
the adjustment of color misalignment is performed using at least two types of data of detection images having different intervals as data of detection images including the plurality of detection patterns.

2. The color image forming apparatus according to claim 1,
wherein the data of detection images includes two types of data composed of first data of detection images and second data of detection images having an interval smaller than that of the first data, and
after the adjustment of color misalignment using the first data is performed, the adjustment of color misalignment using the second data is performed.

3. The color image forming apparatus according to claim 2, wherein the adjustment of color misalignment is performed based on a preset condition using the first data and the second data.

4. A color misalignment adjusting method of a color image forming apparatus, comprising:
a formation step of forming a plurality of detection patterns respectively corresponding to a plurality of colors from a plurality of photosensitive body units respectively corresponding to the plurality of colors onto a transfer member in a sub-scanning direction of the transfer member; and
an adjustment step of detecting intervals between detection patterns adjacent to each other in the sub-scanning direction among the plurality of detection patterns formed in the formation step, and performing adjustment of color misalignment based on the detected intervals;
wherein the plurality of detection patterns have the same size and the same shape, and
the adjustment of color misalignment is performed in the adjustment step using at least two types of data of detection images having different intervals as data of detection images including the plurality of detection patterns.
